(19) United States
(12) Patent Application Publication
(10) Pub. No.: US 2026/0072669 A1
(43) Pub. Date: Mar. 12, 2026

(54) APPLICATION DEPLOYMENT METHOD AND APPARATUS BASED ON CLOUD SERVICE PLATFORM, AND STORAGE MEDIUM

(71) Applicant: Beijing Volcano Engine Technology Co., Ltd., Beijing (CN)

(72) Inventors: Shoucheng ZHU, Beijing (CN); Shaowei GUO, Beijing (CN)

(21) Appl. No.: 19/293,210

(22) Filed: Aug. 7, 2025

(30) Foreign Application Priority Data
Sep. 12, 2024 (CN) 202411283705.9

(51) Int. Cl. G06F 8/61; G06F 21/53

(52) U.S. Cl. CPC G06F 8/63; G06F 21/53; G06F 2221/033

(57) ABSTRACT

The embodiments of the present disclosure provide an application deployment method and apparatus based on a cloud service platform, and a storage medium, which: obtain a static file data package of a customized root file system is obtained, wherein the static file data package is obtained by building a container image and packaging the container image by a root file system configuration device, and the container image is deployed with a binary file of an application; unzip the static file data package to deploy the customized root file system locally; and launch the application in an isolated environment of the customized root file system.

### CROSS-REFERENCE TO RELATED APPLICATION(S)

The present disclosure claims the priority from the CN patent application No. 202411283705.9 entitled “Application deployment method and apparatus based on cloud service platform, and storage medium” filed with the China National Intellectual Property Administration (CNIPA) on Sep. 12, 2024, the contents of which are hereby incorporated by reference in their entirety.

### FIELD

Embodiments of the present disclosure relate to the technical field of computer and network communication, and in particular, to an application deployment method and apparatus based on a cloud service platform, and a storage medium.

### BACKGROUND

There are mainly two types of existing solutions for building an isolated environment, i.e., virtualization technology and containerization technology. The virtualization technology isolates different applications and operating systems by creating virtual machine instances, but due to its heavy resource consumption and long startup time, it may not be efficient enough in some scenarios. In order to overcome some limitations of the virtualization technology and provide a lighter-weight isolation mechanism, the container technology has become an important solution. The container is a lightweight virtualization technology, which utilizes an isolation mechanism at the operating system level to package an application and its dependencies into a portable container image.

### SUMMARY

Embodiments of the present disclosure provide an application deployment method and apparatus based on a cloud service platform, and a storage medium.

In a first aspect, an embodiment of the present disclosure provides an application deployment method based on a cloud service platform, including:

obtaining a static file data package of a customized root file system, wherein the static file data package is obtained by building a container image and packaging the container image by a root file system configuration device, and the container image is deployed with a binary file of an application;

unzipping the static file data package to deploy the customized root file system locally; and

launching the application in an isolated environment of the customized root file system.

In a second aspect, an embodiment of the present disclosure provides an application deployment method based on a cloud service platform, including:

building a container image in a root file system configuration device according to a preset container image building file by using a container image building tool in the root file system configuration device, wherein the container image is deployed with a binary file of an application;

packaging the container image to obtain a static file data package of a customized root file system; and

sending the static file data package to a target physical machine, such that the target physical machine unzips the static file data package to deploy the customized root file system, and launches the application in an isolated environment of the customized root file system.

In a third aspect, an embodiment of the present disclosure provides an application deployment device based on a cloud service platform, including:

an obtaining unit, configured to obtain a static file data package of a customized root file system, wherein the static file data package is obtained by building a container image and packaging the container image by a root file system configuration device, and the container image is deployed with a binary file of an application;

a deployment unit, configured to unzip the static file data package to deploy the customized root file system locally; and

a running unit, configured to launch the application in an isolated environment of the customized root file system.

In a fourth aspect, an embodiment of the present disclosure provides an application deployment device based on a cloud service platform, including:

a building unit, configured to build a container image in a root file system configuration device according to a preset container image building file by using a container image building tool in the root file system configuration device, wherein the container image is deployed with a binary file of an application;

a packaging unit, configured to package the container image to obtain a static file data package of a customized root file system; and

a sending unit, configured to send the static file data package to a target physical machine, such that the target physical machine unzips the static file data package to deploy the customized root file system, and launches the application in an isolated environment of the customized root file system.

In a fifth aspect, an embodiment of the present disclosure provides an electronic device, including: at least one processor and a memory;

the memory stores computer-executable instructions;

the at least one processor executes the computer-executable instructions stored in the memory, such that the at least one processor performs the application deployment method based on a cloud service platform according to the first aspect and various possible designs of the first aspect described above, or the application deployment method based on a cloud service platform according to the second aspect and various possible designs of the second aspect described above.

In a sixth aspect, an embodiment of the present disclosure provides a computer-readable storage medium storing computer-executable instructions which, when executed by a processor, implement the application deployment method based on a cloud service platform according to the first aspect and various possible designs of the first aspect described above, or the application deployment method based on a cloud service platform according to the second aspect and various possible designs of the second aspect described above.

In a seventh aspect, an embodiment of the present disclosure provides a computer program product including computer-executable instructions which, when executed by a processor, implement the application deployment method based on a cloud service platform according to the first aspect and various possible designs of the first aspect described above, or the application deployment method based on a cloud service platform according to the second aspect and various possible designs of the second aspect described above.

### BRIEF DESCRIPTION OF THE DRAWINGS

In order to illustrate the technical solutions in the embodiments of the present disclosure or in the prior art more clearly, the following will briefly introduce the drawings that need to be used in describing the embodiments or the prior art. Obviously, the drawings in the following description are some embodiments of the present disclosure, and for those of ordinary skill in the art, other drawings can also be obtained from these drawings without creative effort.

FIG. 1 is a schematic diagram of a system of an application deployment method based on a cloud service platform according to an embodiment of the present disclosure;

FIG. 2 is a schematic flowchart of an application deployment method based on a cloud service platform according to an embodiment of the present disclosure;

FIG. 3 is a schematic diagram of an architecture of a physical machine according to an embodiment of the present disclosure;

FIG. 4 is a schematic flowchart of an application deployment method based on a cloud service platform according to another embodiment of the present disclosure;

FIG. 5 is a block diagram of an application deployment device based on a cloud service platform according to an embodiment of the present disclosure;

FIG. 6 is a block diagram of an application deployment device based on a cloud service platform according to another embodiment of the present disclosure; and

FIG. 7 is a schematic diagram of a hardware structure of an electronic device according to an embodiment of the present disclosure.

### DETAILED DESCRIPTION OF EMBODIMENTS

In order to make the objects, technical solutions, and advantages of the embodiments of the present disclosure clearer, the technical solutions in the embodiments of the present disclosure will be clearly and completely described below with reference to the drawings in the embodiments of the present disclosure. Obviously, the described embodiments are part of the embodiments of the present disclosure, but not all of them. Based on the embodiments in the present disclosure, all other embodiments obtained by persons of ordinary skill in the art without creative efforts shall fall within the protection scope of the present disclosure.

There are mainly two types of existing solutions for building an isolated environment, i.e., virtualization technology and containerization technology. The virtualization technology isolates different applications and operating systems by creating virtual machine instances, but due to its heavy resource consumption and long startup time, it may not be efficient enough in some scenarios. In order to overcome some limitations of the virtualization technology and provide a lighter-weight isolation mechanism, the container technology has become an important solution. The container is a lightweight virtualization technology, which utilizes an isolation mechanism at the operating system level to package an application and its dependencies into a portable container image.

The container technology provides a complete isolation solution, but some applications only have low isolation requirements during deployment. At this time, introducing the container technology will cause occupation of physical machine resources and additional costs. Therefore, a lightweight isolated environment is needed to isolate the running environment of the application.

The container is a lightweight virtualization technology, which utilizes an isolation mechanism at the operating system level to package an application and its dependencies into a portable container image. This container image contains all the runtime environment, library files, and configurations required by the application, so that the application can run in a consistent manner on any host that supports the container. Different from the virtual machine technology, the container technology does not start an operating system for each container instance, but shares the same operating system in the same host. Essentially, a container is a process running on an operating system, except that isolation and limitation on resources are added. The implementation principle of a container is to group related processes serving the same service objective in the system and place them in the same namespace, wherein each namespace may have its own independent host name, process ID system, IPC, network, file system, user, and other resources, and then limit resources such as CPU and memory that the process can use through Cgroup technology. Docker is one of the specific technical implementations of the containerization technology, and it also depends on Namespaces and Cgroup to implement isolation and limitation on container resources.

In an application scenario, when multiple applications share a server, the running environment of the server physical machine, such as configurations and a lib library, is easily affected by other applications, which may result in failure of launching an application due to modification of a dependent library or a dependent configuration. Therefore, the application has a certain isolation requirement. Although the container can provide an isolated environment, it has the following problems:

The container technology has many dependencies. The Linux system provides various isolation capabilities, but it does not provide native container building capabilities, and still needs to rely on third-party components such as Docker to create containers. The use and maintenance of such systems are relatively complicated, and will also cause certain occupation of physical machine resources. On the other hand, the management capability for containers usually depends on a third-party container orchestration system, such as the most widely used Kubernetes, but while it provides the capability of automated management of containers, it also affects the stability of the containers to a certain extent, such as container eviction. For some applications with high stability requirements, this situation is unacceptable.

In addition, the management of containers mainly depends on third-party container orchestration systems. If the container orchestration system is not used, there is a lack of automated management of containers, and it is impossible to automatically start a container after the physical machine is restarted or retry to build a container environment after a problem occurs. This has a great impact on the stability of the application running.

Moreover, although the container technology can provide a complete isolation solution, some applications only have low isolation requirements during deployment, and mainly expect to run in an independent running environment. They can tolerate using the same process, network, and other namespaces as other applications, and do not require the complete isolation solution of the container technology, but rather need a lightweight isolated environment to isolate the running environment of the application.

In order to solve the above technical problem, an embodiment of the present disclosure provides an application deployment method based on a cloud service platform. The method can utilize a native capability of a Linux system, i.e., a root file system (Rootfs), to provide an isolated application with a running environment independent of a physical machine. The static file data package of the customized root file system is obtained, wherein the static file data package is obtained by building the container image and packaging the container image by the root file system configuration device, and the container image is deployed with the binary file of the application; the static file data package is unzipped to deploy the customized root file system locally; and the application is launched in the isolated environment of the customized root file system. In the embodiments of the present disclosure, the physical machine deploys the customized root file system through the static file data package of the customized root file system, so as to provide a lightweight isolated environment independent of the physical machine environment for the isolated application, without being affected by the physical machine environment, without deploying the container image building tool or the container orchestration system in the physical machine, thereby implementing lightweight deployment of the isolated environment.

The customized root file system in the embodiments of the present disclosure is also a process root file system (Process Root Filesystem, usually referred to as a root file system in “process isolation” or “process namespace”), which can provide each process with an independent view and environment, so that the process can run in an isolated space, avoiding interference with other processes or system environment. Through this mechanism, the process root file system enables each process to have its own file system structure, for example, it can have different files, directories, and mount points, which will not affect other processes or the entire file system in the system. This isolation is crucial for improving the security, stability, and resource management efficiency of the system. The process root file system enables multiple applications to run in parallel on the same host without interfering with each other, while simplifying dependency management and version control.

Embodiments of the present disclosure provide an application deployment method and apparatus based on a cloud service platform, and a storage medium, so as to provide a lightweight isolated environment to isolate a running environment of an application.

In the embodiments of the present disclosure, a physical machine deploys the customized root file system through the static file data package of the customized root file system, so as to provide a lightweight isolated environment independent of a physical machine environment for the isolated application, without deploying a container image building tool or a container orchestration system in the physical machine, thereby implementing lightweight deployment of the isolated environment.

According to the application deployment method and apparatus based on a cloud service platform, and the storage medium provided by the embodiments of the present disclosure, the static file data package of the customized root file system is obtained, wherein the static file data package is obtained by building the container image and packaging the container image by the root file system configuration device, and the container image is deployed with the binary file of the application; the static file data package is unzipped to deploy the customized root file system locally; and the application is launched in the isolated environment of the customized root file system. In the embodiments of the present disclosure, the physical machine deploys the customized root file system through the static file data package of the customized root file system, so as to provide a lightweight isolated environment independent of the physical machine environment for the isolated application, without deploying the container image building tool or the container orchestration system in the physical machine, thereby implementing lightweight deployment of the isolated environment.

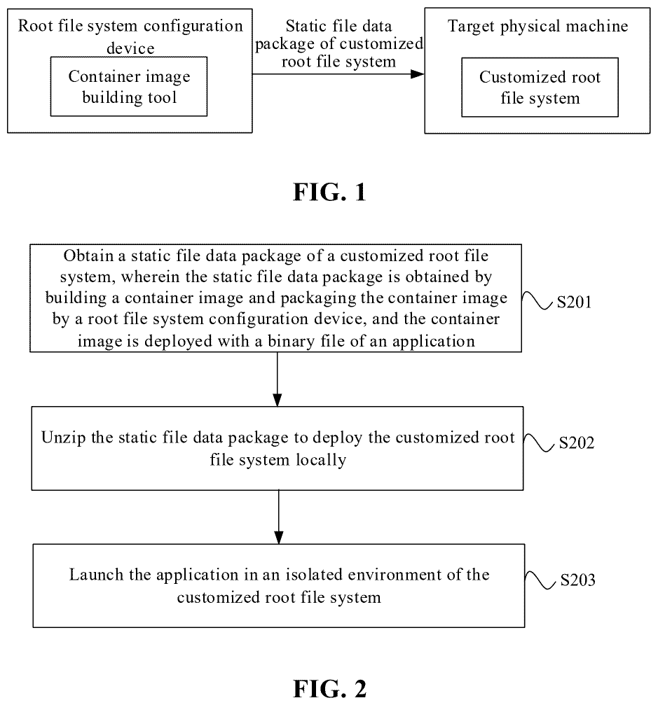

FIG. 1 is a schematic diagram of a system of an application deployment method based on a cloud service platform according to an embodiment of the present disclosure. As shown in FIG. 1, the system includes a target physical machine that needs to deploy a lightweight isolated environment, and a root file system configuration device. The root file system configuration device is deployed with a container image building tool (such as Docker), while the target physical machine does not need to be deployed with the container image building tool. The root file system configuration device builds a container image through the container image building tool and packages the container image to obtain a static file data package of a customized root file system, wherein the container image is deployed with a binary file of an application, and then sends it to the target physical machine. The target physical machine unzips the static file data package to deploy the customized root file system locally, and launches the application in the isolated environment of the customized root file system.

The application deployment method based on a cloud service platform of the present disclosure will be described in detail below with reference to specific embodiments.

Referring to FIG. 2, FIG. 2 is a schematic flowchart of an application deployment method based on a cloud service platform according to an embodiment of the present disclosure. The method of this embodiment can be applied to any target physical machine, wherein the target physical machine may be a physical machine in a cloud service platform, and of course, it may also be not limited to a physical machine in a cloud platform. The application deployment method based on a cloud service platform includes the following steps.

S201, obtaining a static file data package of a customized root file system, wherein the static file data package is obtained by building a container image and packaging the container image by a root file system configuration device, and the container image is deployed with a binary file of an application.

In this embodiment, in order to achieve lightweight, there is no need to deploy a container image building tool (such as Docker) or a container orchestration system (such as Kubernetes) on the target physical machine, but a static file data package of a customized root file system (Rootfs) is obtained, and then the customized root file system (Rootfs) is deployed on the target physical machine after unzipping, so as to build a running environment independent of the physical machine, that is, an isolated environment, for the isolated application.

The static file data package of the customized root file system may be provided by other apparatuses. Optionally, in this embodiment, the static file data package of the customized root file system may be obtained by building the container image and packaging the container image by the root file system configuration device.

Specifically, the root file system configuration device may be any apparatus that can deploy a container image, such as a development-side apparatus. The container image building tool (such as Docker) may be installed on the root file system configuration device. Further, an image building file (Dockerfile) may be written in the container image building tool, or a pre-written image building file may be imported into the container image building tool, wherein the image building file includes a script composed of a series of commands and parameters, and the script contains instructions and descriptions required for building the image one by one. Specifically, the version of the operating system required for the application to run may be specified, and related commands may be used for installing the binary file of the application and the dependent library required for the application to execute, and some customization operations may also be performed, such as modifying a configuration file, configuring an environment variable, and other operations. Then, the container image building tool builds the container image in the root file system configuration device according to the container image building file, wherein any known process may be used for the process of building the container image, which will not be repeated here.

After the container image is built in the root file system configuration device, the container image may be packaged to obtain a folder data package as the static file data package of the customized root file system, and then the root file system configuration device may transmit the static file data package to any target physical machine, and the target physical machine deploys the customized root file system based on the static file data package.

Optionally, since the container image is in a union file system format (UnionFS) and cannot be directly used by the target physical machine without the container image building tool deployed, the file system content of the container image may be exported as a tar archive as the static file data package of the customized root file system by an output command (export command) during packaging, wherein tar is a file packaging format.

Optionally, when the root file system configuration device transmits the static file data package of the customized root file system to the target physical machine, specifically, a file transfer command (scp command, etc.) may be executed to transfer files between the root file system configuration device and the target physical machine; alternatively, the root file system configuration device may upload the static file data package of the customized root file system to an intermediate database, such as a file storage system, and then the target physical machine downloads it from the intermediate database; certainly, it may also be transmitted by any other means, which will not be repeated here.

S202, unzipping the static file data package to deploy the customized root file system locally.

In this embodiment, after obtaining the static file data package of the customized root file system, the target physical machine unzips the static file data package into the target physical machine, so as to obtain a root file system, that is, to deploy the customized root file system locally on the target physical machine. The customized root file system is a process root file system, which can provide the application with an isolated running environment, so that the application can run in this isolated environment. Compared with the process of deploying a container, which requires the container image building tool (such as Docker) to be installed on the target physical machine to build a container image in the container image building tool or to run a container image package packaged by other physical machines, in this embodiment, the target physical machine does not need to deploy the container image building tool, and only needs to unzip the static file data package of the customized root file system to obtain a customized root file system, so as to provide a lightweight isolated environment.

S203, launching the application in an isolated environment of the customized root file system.

In this embodiment, after the customized root file system is deployed locally, the application may be launched and run in the isolated environment of the customized root file system.

Optionally, the application may be launched in at least two of the following manners.

Manner 1: a root file system switching command is executed to switch from a current root file system to the customized root file system, and an application launch instruction is executed to execute the binary file of the application in the isolated environment of the customized root file system.

Manner 2: a binary file of the application is executed in the isolated environment of the customized root file system by a first preset system manager of an operating system of a physical machine according to a root file system field in the first preset system manager, wherein the root file system field is preconfigured with the customized root file system.

In manner 1, since the physical machine may currently be in the root file system of the physical machine or another root file system, if it is necessary to start an application in the automatic root file system, it is necessary to switch from the current root file system to the customized root file system. Optionally, it may be implemented by executing a root file system switching command (chroot command) to switch to the customized root file system; and then the application launch instruction is executed to start executing the binary file of the application in the isolated environment of the customized root file system, thereby starting and running the application.

In manner 2, the application may be started from the isolated environment of the customized root file system in the form of a system manager. The system manager may be systemd, which is an initialization system and a service manager in the Linux operating system. It optimizes the system startup speed by starting services in parallel and using dependencies, and can effectively manage system processes, services, mount points, devices, etc. Systemd uses a single configuration file format to define and manage services, and provides rich command-line tools for users and administrators to conveniently control the state of the service, view logs, and troubleshoot. In addition, systemd also introduces many advanced features, such as service monitoring, automatic restart, resource control (through cgroups), target units (targets), user session management, etc., which significantly improves the flexibility and maintainability of system management. In systemd, the root file system of the service may be specified by setting a root file system field (RootDirectory option) of the service. In this embodiment, a first preset system manager systemd may be pre-constructed in the target physical machine, and the root file system field (RootDirectory option) is additionally specified as the customized root file system in its configuration, and then the binary file of the application may be executed in the isolated environment of the customized root file system through the first preset system manager systemd, thereby starting and running the application.

Certainly, the present embodiment is not limited to the above two manners of starting an application, and other manners of starting an application in the isolated environment of the customized root file system may also be used, which will not be limited here.

Optionally, multiple applications may also run in the same isolated environment of the customized root file system, that is, when the root file system configuration device builds the container image, multiple binary files of applications may be deployed in the container image, and accordingly, the static file data package of the customized root file system includes multiple binary files of applications.

Optionally, the multiple applications may have a certain execution sequence or dependency relationship, so when starting, multiple applications need to be started in turn according to the execution sequence or the dependency relationship. In manner 1, the start instructions of the respective applications may be triggered in turn according to the execution sequence or the dependency relationship, thereby implementing starting the multiple applications in turn. In manner 2, information about the execution sequence and/or the dependency relationship of the multiple applications may be preset in the first preset system manager, for example, a Before field and a Requires field are configured to determine the start sequence of the applications, and then the multiple applications are started in turn in the isolated environment of the customized root file system by the first preset system manager according to the root file system field in the first preset system manager, and the information about the execution sequence and/or the dependency relationship.

Certainly, the above multiple applications may also be not limited to applications in the same customized root file system, and may also be applications in different customized root file systems.

According to the application deployment method based on a cloud service platform provided by the embodiment, the static file data package of the customized root file system is obtained, wherein the static file data package is obtained by building the container image and packaging the container image by the root file system configuration device, and the container image is deployed with the binary file of the application; the static file data package is unzipped to deploy the customized root file system locally; and the application is launched in the isolated environment of the customized root file system. In the embodiment, the physical machine deploys the customized root file system through the static file data package of the customized root file system, so as to provide a lightweight isolated environment independent of the physical machine environment for the isolated application, without deploying the container image building tool or the container orchestration system in the physical machine, thereby implementing lightweight deployment of the isolated environment.

On the basis of any of the above embodiments, after the static file data package is unzipped in S202 to deploy the customized root file system locally, the method may further include:

receiving a capability mount instruction, wherein the capability mount instruction is used for indicating a target mount point in the customized root file system of a target system capability and/or target hardware required for the application to use; and

executing the capability mount instruction to mount a system path corresponding to the target system capability or the target hardware to the target mount point.

In this embodiment, the directory structure of the customized root file system is basically the same as the directory structure of the root file system of the physical machine, but the system capabilities or hardware have not been used yet, that is, the customized root file system is a static folder at this time, lacking the system path for the process to run, such as the system path of some system capabilities and/or the system path of the hardware, and these system capabilities and/or hardware need to be mounted to the customized root file system to be used. For example, if the application needs to use system capabilities such as process management and cgroup management, it is necessary to mount the system path (sys path) from the kernel to the target mount point specified in the customized root file system. If the application needs to use certain hardware, the device path (dev path) of the device file of the hardware is mounted to the target mount point specified in the customized root file system, so that the customized root file system can achieve exactly the same system capabilities and hardware usage capabilities as the physical machine. During specific implementation, the mount operation may be implemented using a capability mount instruction (mount command). In the mount operation, a file type, a target system capability and/or target hardware that need to be mounted, and a target mount point may be specified, so as to implement the mounting of the corresponding system file to the target mount point of the customized root file system, wherein the target mount point is a path of a mount position in the customized root file system.

Optionally, the above mounting process may also be implemented in the form of a system manager, wherein the system manager may be systemd. Specifically, a second preset system manager systemd may be pre-constructed in the target physical machine, and the target system capability and/or target hardware required for the application to use and the target mount point of the target system capability or the target hardware in the customized root file system are preconfigured, and then the system path corresponding to the target system capability or the target hardware is mounted to the target mount point by the second preset system manager systemd.

On the basis of any of the above embodiments, some configurations of the customized root file system may be configured when the root file system configuration device builds the container image, but there are also some configurations that cannot be configured when the root file system configuration device builds the container image, such as some configurations that need to be dynamically loaded, which need to be dynamically loaded from a dynamic library, so it is necessary to execute the configurations at runtime. In this embodiment, at least two manners are also provided to implement the configuration of the customized root file system on the target physical machine.

Manner 1: a configuration instruction of the customized root file system is received, a root file system switching command is executed to switch from a current root file system to the customized root file system, and the configuration instruction is executed to configure an environmental parameter of the customized root file system.

Manner 2: an environmental parameter of the customized root file system is configured by a second preset service manager of an operating system of a physical machine according to preset configuration information in the second preset service manager.

In manner 1, when the configuration instruction is received, it is necessary to switch from the current root file system to the customized root file system before the configuration instruction can be executed for the customized root file system. The switching of the root file system can also be performed by executing the root file system switching command (chroot command) to switch to the path of the customized root file system, and then the configuration operation of the environmental parameter corresponding to the configuration instruction is executed in the directory of the customized root file system, so that the configuration can be read after the application is started.

In manner 2, the configuration of the customized root file system on the target physical machine may also be implemented in the form of a system manager, wherein the system manager may be systemd. Specifically, a second preset system manager systemd may be pre-constructed in the target physical machine, and preset configuration information is preset, and then the environmental parameter of the customized root file system is configured by the second preset system manager systemd according to the preset configuration information in the second preset service manager.

Another advantage of using manner 2 for configuration is that configuration failure when the physical machine restarts can be avoided. When the physical machine restarts, the customized root file system may be reconfigured automatically by the second preset service manager according to the preset configuration information. Similarly, the above mounting of the target system capability or the target hardware is implemented by using the second preset system manager, which may also avoid the loss of the mount when the physical machine restarts. When the physical machine restarts, the file corresponding to the target system capability or the target hardware may be automatically remounted to the target mount point by the second preset service manager. By using the second preset service manager, remounting and reconfiguring the target system capability or the target hardware for the customized root file system may be implemented after the physical machine restarts, without manual execution, thereby improving the automation and convenience.

It should be noted that in the above embodiments, before the application is launched in the isolated environment of the customized root file system, the mounting of the target system capability or the target hardware to the customized root file system and the configuration of the customized root file system must be completed, so as to prevent the application from being started before the isolated environment is completely built, and its configuration does not meet expectations.

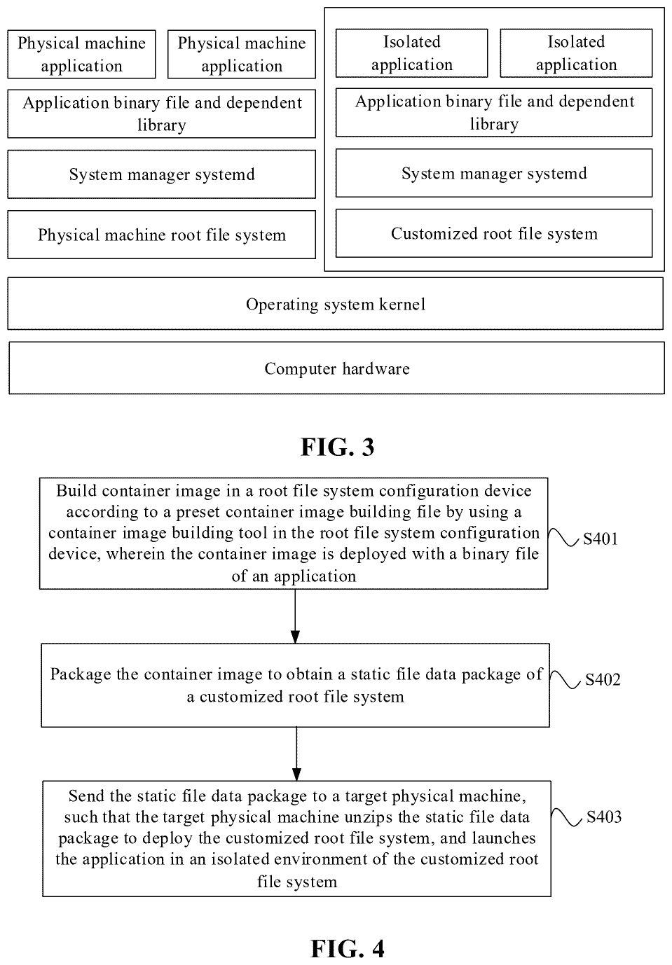

On the basis of the above embodiments, the specific architecture of the target physical machine may be as shown in FIG. 3. On the left side above the operating system kernel and computer hardware is the architecture of the applications deployed in the root file system of the physical machine. The binary files (Bin) and dependent libraries (lib library) of these physical machine applications are all deployed on the root file system of the physical machine, and may be managed and deployed by a system manager systemd. On the right side is the manner provided by this embodiment, that is, a customized root file system independent of the root file system of the physical machine is deployed, on which the binary file (Bin) and the dependent library (lib library) of the isolated application are deployed. One or more system managers systemd may be used for managing and deploying the environment and configuration of the customized root file system, and the start control of the application may also be performed.

In an optional embodiment, after the target physical machine obtains the static file data package of the customized root file system, the static file data package may be unzipped; the system path corresponding to the target system capability or the target hardware required for the application is mounted to the target mount point in the customized root file system; the customized root file system is switched to, and the environmental parameter of the customized root file system is configured; and then the application is launched in the isolated environment of the customized root file system. Specifically, a first preset system manager may be configured first, and the root file system field in the first preset system manager is configured as the customized root file system, that is, to specify that the application is executed in the customized root file system. If multiple applications are involved, the start sequence of the multiple applications may also be configured. Further, the binary file of the application is executed in the isolated environment of the customized root file system by the first preset system manager according to the root file system field, so as to implement the start of the application.

Referring to FIG. 4, FIG. 4 is a schematic flowchart of an application deployment method based on a cloud service platform according to an embodiment of the present disclosure. The method of this embodiment may be applied to the root file system configuration device, wherein the root file system configuration device may be any apparatus that can deploy the container image building tool, such as a physical machine. The application deployment method based on a cloud service platform includes the following steps.

S401, building a container image in a root file system configuration device according to a preset container image building file by using a container image building tool in the root file system configuration device, wherein the container image is deployed with a binary file of an application.

S402, packaging the container image to obtain a static file data package of a customized root file system.

S403, sending the static file data package to a target physical machine, such that the target physical machine unzips the static file data package to deploy the customized root file system, and launches the application in an isolated environment of the customized root file system.

This embodiment is a method embodiment on the root file system configuration device side, and for its specific principles and technical effects, reference may be made to the above method embodiment on the target physical machine side, which will not be repeated here.

The method on the root file system configuration device side provided by this embodiment can provide the static file data package of the customized root file system for one or more target physical machines, so that there is no need to redeploy the container image building tool or the container orchestration system on the target physical machine. The target physical machine only needs to deploy the customized root file system through the static file data package of the customized root file system, so as to provide a lightweight isolated environment independent of the physical machine environment for the isolated application, thereby implementing lightweight deployment of the isolated environment.

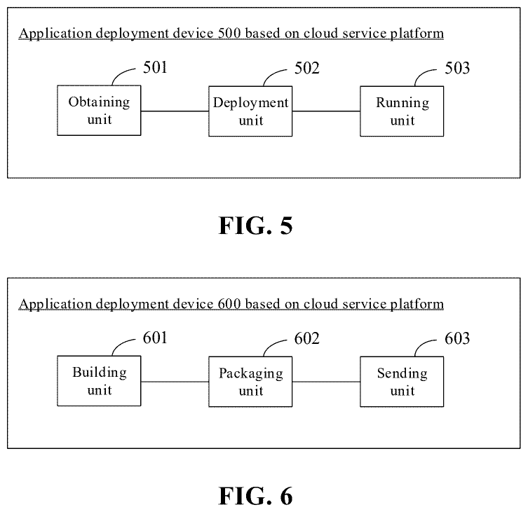

Corresponding to the application deployment method based on a cloud service platform on the target physical machine side in the above embodiment, FIG. 5 is a block diagram of an application deployment device based on a cloud service platform according to an embodiment of the present disclosure. For ease of description, only parts related to the embodiments of the present disclosure are shown. Referring to FIG. 5, the application deployment device 500 based on a cloud service platform includes: an obtaining unit 501, a deployment unit 502, and a running unit 503.

The obtaining unit 501 is configured to obtain a static file data package of a customized root file system, wherein the static file data package is obtained by building a container image and packaging the container image by a root file system configuration device, and the container image is deployed with a binary file of an application.

The deployment unit 502 is configured to unzip the static file data package to deploy the customized root file system locally.

The running unit 503 is configured to launch the application in an isolated environment of the customized root file system.

In one or more embodiments of the present disclosure, when launching the application in the isolated environment of the customized root file system, the running unit 503 is configured to:

execute a root file system switching command to switch from a current root file system to the customized root file system, and execute an application launch instruction to execute the binary file of the application in the isolated environment of the customized root file system; or

execute the binary file of the application in the isolated environment of the customized root file system by a first preset system manager of an operating system of a physical machine according to a root file system field in the first preset system manager, wherein the root file system field is preconfigured with the customized root file system.

In one or more embodiments of the present disclosure, there are multiple applications, and information about the execution sequence and/or the dependency relationship of the multiple applications is preset in the first preset system manager.

Accordingly, when launching the application in the isolated environment of the customized root file system by the first preset system manager of the operating system of the physical machine according to the root file system field in the first preset system manager, the running unit 503 is configured to:

launch the multiple applications in turn in the isolated environment of the customized root file system by the first preset system manager according to the root file system field in the first preset system manager, and the information about the execution sequence and/or the dependency relationship.

In one or more embodiments of the present disclosure, after unzipping the static file data package to deploy the customized root file system locally, the deployment unit 502 is further configured to:

receive a capability mount instruction, wherein the capability mount instruction is used for indicating a target mount point in the customized root file system of a target system capability and/or target hardware required for the application to use, and executing the capability mount instruction to mount a system path corresponding to the target system capability or the target hardware to the target mount point; or

mount the system path corresponding to the target system capability or the target hardware to the target mount point by a second preset service manager of the operating system of the physical machine according to a target mount point in the customized root file system of a target system capability and/or a target hardware required for the application preset in the second preset service manager to use.

In one or more embodiments of the present disclosure, before launching the application in the isolated environment of the customized root file system, the deployment unit 502 is further configured to:

receive a configuration instruction of the customized root file system, execute a root file system switching command to switch from a current root file system to the customized root file system, and execute the configuration instruction to configure an environmental parameter of the customized root file system; or

configure the environmental parameter of the customized root file system by a second preset service manager of the operating system of the physical machine according to preset configuration information in the second preset service manager.

In one or more embodiments of the present disclosure, the deployment unit 502 is further configured to:

reconfigure the environmental parameter of the customized root file system by the second preset service manager according to the preset configuration information in the second preset service manager after the physical machine restarts.

The apparatus provided by this embodiment can be used for implementing the technical solutions of the above method embodiments, and the implementation principle and technical effects thereof are similar, which will not be repeated here in this embodiment.

Corresponding to the application deployment method based on a cloud service platform on the root file system configuration device side in the above embodiment, FIG. 6 is a block diagram of an application deployment device based on a cloud service platform according to an embodiment of the present disclosure. For ease of description, only parts related to the embodiments of the present disclosure are shown. Referring to FIG. 6, the application deployment device 600 based on a cloud service platform includes: a building unit 601, a packaging unit 602, and a sending unit 603.

The building unit 601 is configured to build a container image in a root file system configuration device according to a preset container image building file by using a container image building tool in the root file system configuration device, wherein the container image is deployed with a binary file of an application.

The packaging unit 602 is configured to package the container image to obtain a static file data package of a customized root file system.

The sending unit 603 is configured to send the static file data package to a target physical machine, such that the target physical machine unzips the static file data package to deploy the customized root file system, and launches the application in an isolated environment of the customized root file system.

The apparatus provided by this embodiment can be used for implementing the technical solutions of the above method embodiments, and the implementation principle and technical effects thereof are similar, which will not be repeated here in this embodiment.

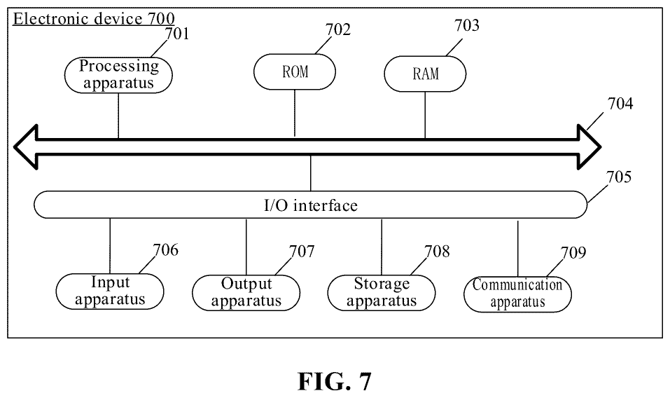

Reference is made to FIG. 7, which illustrates a schematic diagram of a structure of an electronic device 700 suitable for implementing the embodiments of the present disclosure. The electronic device 700 may be a terminal device or a server. The terminal device may include, but is not limited to, mobile terminals such as a mobile phone, a laptop, a digital broadcast receiver, a personal digital assistant (PDA), a tablet computer, a portable media player (PMP), and a vehicle-mounted terminal (such as a vehicle navigation terminal), and fixed terminals such as a digital TV and a desktop computer. The electronic device shown in FIG. 7 is only an example, and should not impose any limitation on the function and scope of use of the embodiments of the present disclosure.

As shown in FIG. 7, the electronic device 700 may include a processing apparatus (such as a central processing unit, a graphics processor, etc.) 701, which may perform various appropriate actions and processing according to a program stored in a read-only memory (abbreviated as ROM) 702 or a program loaded from a storage apparatus 708 into a random access memory (abbreviated as RAM) 703. The RAM 703 also stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, a gyroscope, and the like; an output apparatus 707 including, for example, a liquid crystal display (abbreviated as LCD), a speaker, a vibrator, and the like; a storage apparatus 708 including, for example, a magnetic tape, a hard disk, and the like; and a communication apparatus 709. The communication apparatus 709 may allow the electronic device 700 to perform wireless or wired communication with other devices to exchange data. Although FIG. 7 shows the electronic device 700 having various apparatuses, it should be understood that not all of the illustrated apparatuses are necessarily implemented or included. Alternatively, more or fewer apparatuses may be implemented or included.

In particular, according to the embodiments of the present disclosure, the processes described above with reference to the flowcharts can be implemented as computer software programs. For example, the embodiments of the present disclosure include a computer program product, which includes a computer program carried on a computer-readable medium, and the computer program includes program codes for executing the methods shown in the flowcharts. In such embodiments, the computer program may be downloaded and installed from the network through the communication apparatus 709, or installed from the storage apparatus 708, or installed from the ROM 702. When the computer program is executed by the processing apparatus 701, the above-mentioned functions defined in the methods of the embodiments of the present disclosure are executed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier wave, and computer-readable program codes are carried therein. Such propagated data signals may take a variety of forms, including but not limited to electromagnetic signals, optical signals, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to: a wire, an optical cable, a radio frequency (RF), or any suitable combination thereof.

The above-mentioned computer-readable medium may be included in the electronic device, or may also exist alone without being assembled into the electronic device.

The above-mentioned computer-readable medium carries one or more programs, and when the above-mentioned one or more programs are executed by the electronic device, the electronic device is caused to execute the methods shown in the above-mentioned embodiments.

The computer program codes for performing the operations in the present disclosure may be written in one or more programming languages or a combination thereof, wherein the above-mentioned programming languages include object-oriented programming languages such as Java, Smalltalk, C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or a server. In the scenario involving the remote computer, the remote computer may be connected to the user's computer through any kind of network, including a Local Area Network (LAN for short) or a Wide Area Network (WAN for short), or may be connected to an external computer (for example, connected via the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may occur out of the order noted in the drawings. For example, two blocks shown in succession may, in fact, can be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The described units involved in the embodiments of the present disclosure may be implemented by software or hardware. The name of the unit does not constitute a limitation on the unit itself under certain circumstances. For example, the first acquisition unit may also be described as “a unit that acquires at least two internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, one or more embodiments of the present disclosure provide an application deployment method based on a cloud service platform, including:

obtaining a static file data package of a customized root file system, wherein the static file data package is obtained by building a container image and packaging the container image by a root file system configuration device, and the container image is deployed with a binary file of an application;

unzipping the static file data package to deploy the customized root file system locally; and

launching the application in an isolated environment of the customized root file system.

According to one or more embodiments of the present disclosure, the launching the application in the isolated environment of the customized root file system includes:

executing a root file system switching command to switch from a current root file system to the customized root file system, and executing an application launch instruction to execute the binary file of the application in the isolated environment of the customized root file system; or

executing the binary file of the application in the isolated environment of the customized root file system by a first preset system manager of an operating system of a physical machine according to a root file system field in the first preset system manager, wherein the root file system field is preconfigured with the customized root file system.

According to one or more embodiments of the present disclosure, there are multiple applications, and information about the execution sequence and/or the dependency relationship of the multiple applications is preset in the first preset system manager.

Accordingly, the launching the application in the isolated environment of the customized root file system by the first preset system manager of the operating system of the physical machine according to the root file system field in the first preset system manager includes:

launching the multiple applications in turn in the isolated environment of the customized root file system by the first preset system manager according to the root file system field in the first preset system manager, and the information about the execution sequence and/or the dependency relationship.

According to one or more embodiments of the present disclosure, after unzipping the static file data package to deploy the customized root file system locally, the method further includes:

receiving a capability mount instruction, wherein the capability mount instruction is used for indicating a target mount point in the customized root file system of a target system capability and/or target hardware required for the application to use, and executing the capability mount instruction to mount a system path corresponding to the target system capability or the target hardware to the target mount point; or

mounting the system path corresponding to the target system capability or the target hardware to the target mount point by a second preset service manager of the operating system of the physical machine according to a target mount point in the customized root file system of a target system capability and/or a target hardware required for the application preset in the second preset service manager to use.

According to one or more embodiments of the present disclosure, before launching the application in the isolated environment of the customized root file system, the method further includes:

receiving a configuration instruction of the customized root file system, executing a root file system switching command to switch from a current root file system to the customized root file system, and executing the configuration instruction to configure an environmental parameter of the customized root file system; or

configuring the environmental parameter of the customized root file system by a second preset service manager of the operating system of the physical machine according to preset configuration information in the second preset service manager.

According to one or more embodiments of the present disclosure, the method further includes:

reconfiguring the environmental parameter of the customized root file system by the second preset service manager according to the preset configuration information in the second preset service manager after the physical machine restarts.

In a second aspect, one or more embodiments of the present disclosure provide an application deployment method based on a cloud service platform, including:

building a container image in a root file system configuration device according to a preset container image building file by using a container image building tool in the root file system configuration device, wherein the container image is deployed with a binary file of an application;

packaging the container image to obtain a static file data package of a customized root file system; and

sending the static file data package to a target physical machine, such that the target physical machine unzips the static file data package to deploy the customized root file system, and launches the application in an isolated environment of the customized root file system.

In a third aspect, one or more embodiments of the present disclosure provide an application deployment device based on a cloud service platform, including:

an obtaining unit, configured to obtain a static file data package of a customized root file system, wherein the static file data package is obtained by building a container image and packaging the container image by a root file system configuration device, and the container image is deployed with a binary file of an application;

a deployment unit, configured to unzip the static file data package to deploy the customized root file system locally; and

a running unit, configured to launch the application in an isolated environment of the customized root file system.

According to one or more embodiments of the present disclosure, when launching the application in the isolated environment of the customized root file system, the running unit is configured to:

execute a root file system switching command to switch from a current root file system to the customized root file system, and execute an application launch instruction to execute the binary file of the application in the isolated environment of the customized root file system; or

execute the binary file of the application in the isolated environment of the customized root file system by a first preset system manager of an operating system of a physical machine according to a root file system field in the first preset system manager, wherein the root file system field is preconfigured with the customized root file system.

According to one or more embodiments of the present disclosure, there are multiple applications, and information about the execution sequence and/or the dependency relationship of the multiple applications is preset in the first preset system manager.

Accordingly, when launching the application in the isolated environment of the customized root file system by the first preset system manager of the operating system of the physical machine according to the root file system field in the first preset system manager, the running unit is configured to:

launch the multiple applications in turn in the isolated environment of the customized root file system by the first preset system manager according to the root file system field in the first preset system manager, and the information about the execution sequence and/or the dependency relationship.

According to one or more embodiments of the present disclosure, after unzipping the static file data package to deploy the customized root file system locally, the deployment unit is further configured to:

receive a capability mount instruction, wherein the capability mount instruction is used for indicating a target mount point in the customized root file system of a target system capability and/or target hardware required for the application to use, and executing the capability mount instruction to mount a system path corresponding to the target system capability or the target hardware to the target mount point; or

mount the system path corresponding to the target system capability or the target hardware to the target mount point by a second preset service manager of the operating system of the physical machine according to a target mount point in the customized root file system of a target system capability and/or a target hardware required for the application preset in the second preset service manager to use.

According to one or more embodiments of the present disclosure, before launching the application in the isolated environment of the customized root file system, the deployment unit is further configured to:

receive a configuration instruction of the customized root file system, execute a root file system switching command to switch from a current root file system to the customized root file system, and execute the configuration instruction to configure an environmental parameter of the customized root file system; or

configure the environmental parameter of the customized root file system by a second preset service manager of the operating system of the physical machine according to preset configuration information in the second preset service manager.

According to one or more embodiments of the present disclosure, the deployment unit is further configured to:

reconfigure the environmental parameter of the customized root file system by the second preset service manager according to the preset configuration information in the second preset service manager after the physical machine restarts.

In a fourth aspect, one or more embodiments of the present disclosure provide an application deployment device based on a cloud service platform, including:

a building unit, configured to build a container image in a root file system configuration device according to a preset container image building file by using a container image building tool in the root file system configuration device, wherein the container image is deployed with a binary file of an application;

a packaging unit, configured to package the container image to obtain a static file data package of a customized root file system; and

a sending unit, configured to send the static file data package to a target physical machine, such that the target physical machine unzips the static file data package to deploy the customized root file system, and launches the application in an isolated environment of the customized root file system.

In a fifth aspect, one or more embodiments of the present disclosure provide an electronic device, including: at least one processor and a memory;

where the memory stores computer-executable instructions; and

the at least one processor executes the computer-executable instructions stored in the memory to cause the at least one processor to execute the application deployment method based on a cloud service platform according to the first aspect and various possible designs of the first aspect, or the application deployment method based on a cloud service platform according to the second aspect and various possible designs of the second aspect.

In a sixth aspect, one or more embodiments of the present disclosure provide a computer-readable storage medium, wherein the computer-readable storage medium stores computer-executable instructions, and when a processor executes the computer-executable instructions, the application deployment method based on a cloud service platform according to the first aspect and various possible designs of the first aspect, or the application deployment method based on a cloud service platform according to the second aspect and various possible designs of the second aspect is implemented.

In a seventh aspect, one or more embodiments of the present disclosure provide a computer program product, including computer-executable instructions, and when a processor executes the computer-executable instructions, the application deployment method based on a cloud service platform according to the first aspect and various possible designs of the first aspect, or the application deployment method based on a cloud service platform according to the second aspect and various possible designs of the second aspect is implemented.

The above description is merely preferred embodiments of the present disclosure and the illustration of the applied technical principles. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or equivalent features thereof. For example, the technical solutions formed by replacing the above features with the technical features with similar functions disclosed (but not limited to) in the present disclosure.

In addition, although operations are depicted in a particular order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. Rather, the specific features and actions described above are merely example forms for implementing the claims.

I/We claim:

1. An application deployment method based on a cloud service platform, comprising:
obtaining a static file data package of a customized root file system, wherein the static file data package is obtained by building a container image and packaging the container image by a root file system configuration device, and the container image is deployed with a binary file of an application;
unzipping the static file data package to deploy the customized root file system locally; and
launching the application in an isolated environment of the customized root file system.

2. The method according to claim 1, wherein launching the application in the isolated environment of the customized root file system comprises:
executing a root file system switching command to switch from a current root file system to the customized root file system, and executing an application launch instruction to execute the binary file of the application in the isolated environment of the customized root file system; or
executing the binary file of the application in the isolated environment of the customized root file system by a first preset system manager of an operating system of a physical machine according to a root file system field in the first preset system manager, wherein the root file system field is preconfigured with the customized root file system.

3. The method according to claim 2, wherein there are multiple applications, and information about an execution sequence and/or a dependency relationship of the multiple applications is preset in the first preset system manager; and
launching the application in the isolated environment of the customized root file system by the first preset system manager of the operating system of the physical machine according to the root file system field in the first preset system manager comprises:
launching the multiple applications in turn in the isolated environment of the customized root file system by the first preset system manager according to the root file system field in the first preset system manager and the information about the execution sequence and/or the dependency relationship.

4. The method according to claim 1, wherein after unzipping the static file data package to deploy the customized root file system locally, the method further comprises:
receiving a capability mount instruction, wherein the capability mount instruction is used for indicating a target mount point in the customized root file system of a target system capability and/or a target hardware required for the application to use, and executing the capability mount instruction to mount a system path corresponding to the target system capability or the target hardware to the target mount point; or
mounting the system path corresponding to the target system capability or the target hardware to the target mount point by a second preset service manager of the operating system of the physical machine according to a target mount point in the customized root file system of a target system capability and/or a target hardware required for the application preset in the second preset service manager to use.

5. The method according to claim 1, wherein before launching the application in the isolated environment of the customized root file system, the method further comprises:
receiving a configuration instruction of the customized root file system, executing a root file system switching command to switch from a current root file system to the customized root file system, and executing the configuration instruction to configure an environmental parameter of the customized root file system; or
configuring the environmental parameter of the customized root file system by a second preset service manager of the operating system of the physical machine according to preset configuration information in the second preset service manager.

6. The method according to claim 5, wherein the method further comprises:
reconfiguring the environmental parameter of the customized root file system by the second preset service manager according to the preset configuration information in the second preset service manager after the physical machine restarts.

7. An application deployment method based on a cloud service platform, comprising:
building a container image in a root file system configuration device according to a preset container image building file by using a container image building tool in the root file system configuration device, wherein the container image is deployed with a binary file of an application;
packaging the container image to obtain a static file data package of a customized root file system; and
sending the static file data package to a target physical machine, such that the target physical machine unzips the static file data package to deploy the customized root file system, and launches the application in an isolated environment of the customized root file system.

8. An electronic device, comprising: at least one processor and a memory, wherein:
the memory stores computer-executable instructions; and
the at least one processor executes the computer-executable instructions stored in the memory to cause the at least one processor to execute an application deployment method comprising:
obtaining a static file data package of a customized root file system, wherein the static file data package is obtained by building a container image and packaging the container image by a root file system configuration device, and the container image is deployed with a binary file of an application;
unzipping the static file data package to deploy the customized root file system locally; and
launching the application in an isolated environment of the customized root file system.

9. The electronic device according to claim 8, wherein launching the application in the isolated environment of the customized root file system comprises:
executing a root file system switching command to switch from a current root file system to the customized root file system, and executing an application launch instruction to execute the binary file of the application in the isolated environment of the customized root file system; or
executing the binary file of the application in the isolated environment of the customized root file system by a first preset system manager of an operating system of a physical machine according to a root file system field in the first preset system manager, wherein the root file system field is preconfigured with the customized root file system.

10. The electronic device according to claim 9, wherein there are multiple applications, and information about an execution sequence and/or a dependency relationship of the multiple applications is preset in the first preset system manager; and
launching the application in the isolated environment of the customized root file system by the first preset system manager of the operating system of the physical machine according to the root file system field in the first preset system manager comprises:
launching the multiple applications in turn in the isolated environment of the customized root file system by the first preset system manager according to the root file system field in the first preset system manager and the information about the execution sequence and/or the dependency relationship.

11. The electronic device according to claim 8, wherein after unzipping the static file data package to deploy the customized root file system locally, the method further comprises:
receiving a capability mount instruction, wherein the capability mount instruction is used for indicating a target mount point in the customized root file system of a target system capability and/or a target hardware required for the application to use, and executing the capability mount instruction to mount a system path corresponding to the target system capability or the target hardware to the target mount point; or
mounting the system path corresponding to the target system capability or the target hardware to the target mount point by a second preset service manager of the operating system of the physical machine according to a target mount point in the customized root file system of a target system capability and/or a target hardware required for the application preset in the second preset service manager to use.

12. The electronic device according to claim 8, wherein before launching the application in the isolated environment of the customized root file system, the method further comprises:
receiving a configuration instruction of the customized root file system, executing a root file system switching command to switch from a current root file system to the customized root file system, and executing the configuration instruction to configure an environmental parameter of the customized root file system; or
configuring the environmental parameter of the customized root file system by a second preset service manager of the operating system of the physical machine according to preset configuration information in the second preset service manager.

13. The electronic device according to claim 8, wherein the method further comprises:
reconfiguring the environmental parameter of the customized root file system by the second preset service manager according to the preset configuration information in the second preset service manager after the physical machine restarts.
